(19) United States
(12) Patent Application Publication
(10) Pub. No.: US 2022/0184481 A1
(43) Pub. Date: Jun. 16, 2022

(54) Game Status Detection and Trajectory Fusion

(71) Applicant: Intel Corporation, Santa Clara, CA (US)

(72) Inventors: Xiaofeng Tong, Beijing (CN); Qiang Li, Beijing (CN); Wenlong Li, Beijing (CN); Haihua Lin, Beijing (CN); Ming Lu, Beijing (CN)

(21) Appl. No.: 17/438,393

(22) PCT Filed: Jul. 31, 2019
(86) PCT No.: PCT/CN2019/098516

§ 371 Date: Sep. 10, 2021

(51) Int. Cl. A63B 71/06; G06N 5/02

(52) U.S. Cl. CPC A63B 71/0619; A63B 2243/0066; G06N 5/02

(57) ABSTRACT

An example system for game status detection and trajectory fusion is described herein. The system includes a tracker to obtain a ball position and a player position based on images from a plurality of cameras and a fusion controller to combine multiple trajectories that are detected via the ball position to obtain a fused trajectory. The system also includes a finite state machine configured to model a game pattern, wherein a game status is determined via the ball position, the player position and the fused trajectory as input to the finite state machine.

### RELATED APPLICATION

This application is a National Phase of International Application No. PCT/CN2019/098516, filed on Jul. 31, 2019, which is hereby incorporated by reference in its entirety.

### BACKGROUND

Multiple cameras are used to capture activity in a scene and enable end users to view the scene and move throughout the scene in a full 360 degrees. For example, multiple cameras may be used to capture a sports game and end users can move throughout the field of play freely. The end user may also view the game from a virtual camera.

### BRIEF DESCRIPTION OF THE DRAWINGS

FIG. 1 includes a game status monitor and immersive viewing modules;

FIG. 2 is a block diagram illustrating a field of play;

FIG. 3 is a block diagram illustrating the parsing of a round of play into a plurality of states;

FIG. 4 is a block diagram illustrating a timeline with states and stages of a down in an American football game;

FIG. 5 is a game state transition graph;

FIG. 6A is an illustration of multiple trajectories;

FIG. 6B is an illustration of a fused trajectory;

FIG. 7 is a process flow diagram of a method for game status detection;

FIG. 8 is an illustration of a process flow diagram of a multiple-camera ball location method;

FIG. 9 is a process flow diagram illustrating a method for ball location fusion;

FIG. 10 is a process flow diagram of a method for game status detection with ball location fusion;

FIG. 11 is a block diagram illustrating game status detection and trajectory fusions; and

FIG. 12 is a block diagram showing computer readable media that store code for game status detection and trajectory fusion

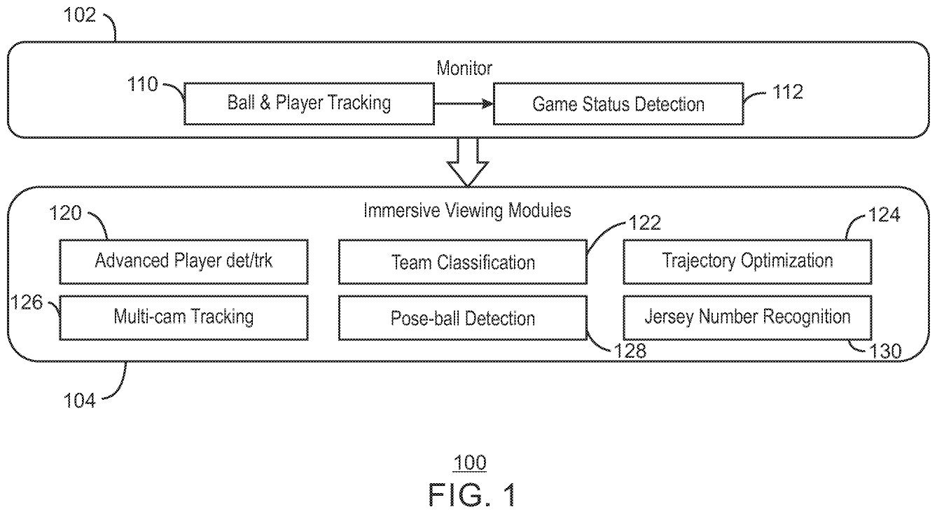

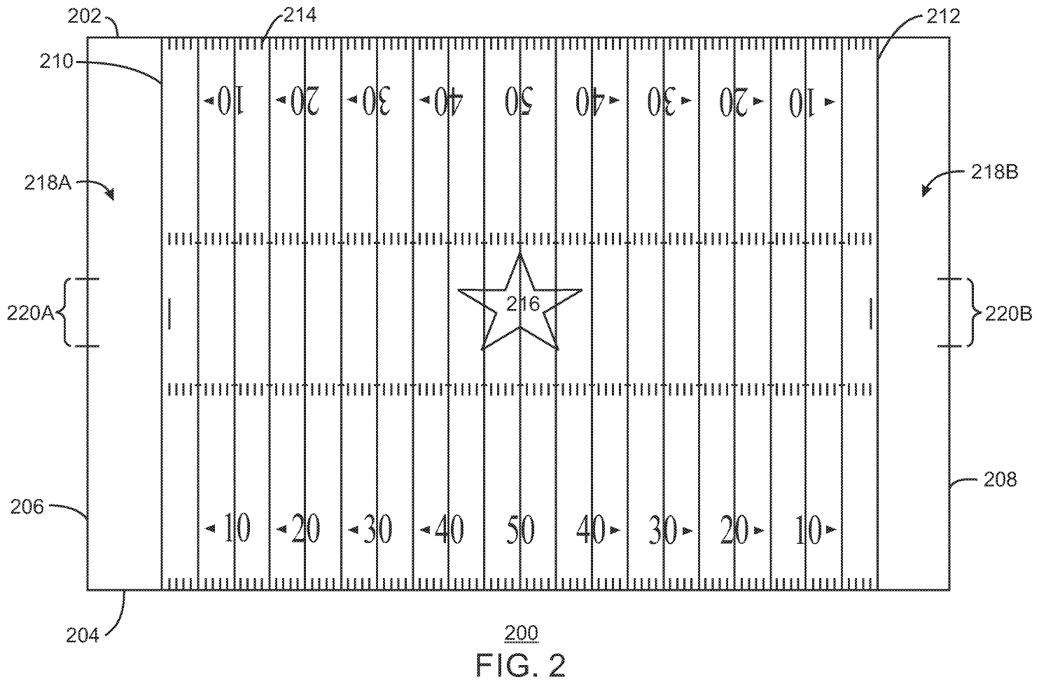

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Sporting events and other competitions are often broadcast for the entertainment of end users. These games may be rendered in a variety of formats. For example, a game can be rendered as a two-dimensional video or a three-dimensional video. The games may be captured using one or more high-resolution cameras positioned around an entire field of play. The plurality of cameras may capture an entire three-dimensional volumetric space, including the field of play. In embodiments, the camera system may include multiple super high-resolution cameras for volumetric capture. The end users can view the action of the game and move through the captured volume freely. Additionally, an end user can view the game from a virtual camera that follows the action within the field by following the ball or a specific player in the three-dimensional volumetric space. Providing such an immersive experience may be based, in part, on automatically tracking the ball and players with high accuracy in real time. Moreover, as system as described herein also automatically tracks the ball and detects highlight moments during gameplay in real time. In this manner, an immersive media experience is provided to end users in real-time.

The present techniques enable game status detection via a number of modules. The modules may be enabled or disabled based on a game status. As used herein, the game status may refer to a particular state of the game. The states of the game may correspond to particular rounds of play, particular breaks during play, special plays, overtime, the score, the team in possession of the ball, the team without possession of the ball, the game clock, time remaining during the round of play, or any combination thereof. With this mechanism, the game status can be monitored, and the compute modules dynamically configured to deliver a highly effective and cast-saving system. Moreover, the present techniques enable the detection of a ball during a game, including when the ball is visible and invisible. If the ball is visible, a direct object detection algorithm is used. Otherwise, the ball location may be detected based on the location of a ball holding player. The ball position may be inferred from the position of the ball holding player and fused with other ball locations according to a fusion algorithm.

As used herein, a game may refer to a form of play according to a set of rules. The game may be played for recreation, entertainment, or achievement. The game may have an audience of spectators that observe the game. The spectators may be referred to as end-users. The game may be competitive in nature and organized such that opposing individuals or teams compete to win. A win refers to a first individual or first team being recognized as triumphing over other individuals or teams. A win may also result in an individual or team meeting or securing an achievement. Often, the game is played on a field, court, within an arena, or some other area designated for game play. The area designated for game play typically includes markings, goal posts, nets, and the like to facilitate game play. For ease of description, the present techniques are described using football. However, any game may be used according to the present techniques.

FIG. 1 is a block diagram usage of game status detection. In embodiments, a status of a game may be monitored according to a game state. Based on the game state, various modules may be used to enable an immersive media experience within the game. In some cases, the immersive media experience is provided in real-time. Alternatively, the immersive media experience may be a replay of a previous game. In an immersive media experience as described herein, an end user can follow the ball and players in a full 360 degrees freedom of movement within the field of play.

FIG. 1 includes a game status monitor 102 and immersive viewing modules 104. The game status monitor may include a ball and player tracking module 110 and a game status detection module 112. The game status monitor 102 may provide information such as ball position, player position, and game status to the immersive viewing modules 104. As illustrated, information from the ball and player tracking module 110 may be used by the game status detection module 112. As described below, movement of the ball or movement of a player may cause the game to enter one state of a plurality of states. Accordingly, the status of a game can be determined based on the particular location of the ball, the players, and the action applied to the ball, the players. In the ball and player tracking at block 110, the ball may be detected by first resizing the image. The image may then be segmented into multiple bounding boxes and class probabilities. A single convolutional network may simultaneously predict the multiple bounding boxes and class probabilities for the multiple boxes. An object may be associated with each bounding box. The single convolutional network may be trained using full images. In some cases, the training images may be images associated with a particular sport. In embodiments, the ball is relatively small. For example, when rendered the ball may be approximately 20 pixels in 1 k image. Thus, a small bounding box may be used to track the ball. The ball and player tracking module uses a deep convolutional neural network (CNN) technology that detects the relatively tiny ball. In embodiments, the ball may be detected based on an you only look once (YOLO) approach in a multi-camera framework.

At block 110, player detection and tracking may occur according to various modes based on a layout of the players within the field of play. Player detection and tracking may also occur according to various modes based on the movement of the players within the field of play. Each player detection mode models a different performance for a different purpose. For example, a “quick” player detection and tracking mode uses a simple but fast model to detect players, while an elaborate player detection and tracking mode uses a complex, accurate model to detect players in a frame. In the game status monitor 102, the quick model is used to quickly find players, and to quickly know how many players are within the field of play and their layout. In some cases, if the number of players within the field of play is incorrect, the game may be in a break state. If players are in a position recognized as a game play layout, the game may be in a game start state. For example, in American football, lining up in a kickoff formation may indicate a state as the start of the game or the start of the second half of play. Lining up in a punt formation may indicate a turnover has occurred. Additionally, both teams lining up along the line of scrimmage indicates the beginning of a down. In embodiments, a game state may be indicated by the particular formation or packages of the players.

The game status monitor 102 may provide information such as ball position or trajectory, player position or trajectory, and game status, and any combination thereof to the immersive viewing modules 104. In embodiments, the immersive viewing modules 104 enable an immersive experience of a game. The immersive viewing modules 104 include an advance player detection and tracking module 120. The advance player detection and tracking module may enable highly accurate detection and tracking of a player in view of occlusions and multiple players in a frame. A team classification module 122 may be used to assign each player within the field of play to a particular team. In embodiments, the team classification module 122 enables players of each team to be grouped together for further rendering or processing. A trajectory optimization module 124 optimizes various trajectories that occur during gameplay. For example, the trajectory optimization module 124 may optimize a trajectory found by the advanced player detection and tracking module 120 or supplied by the game status monitor 102. In particular, the trajectory optimization module may infer various portions of a player trajectory when the player is obscured from view. The trajectory optimization module 124 may also optimize the trajectory of the ball.

A multi-camera tracking module 126 may be used to track the ball. In particular, the multi-camera tracking module 126 may track the 2D ball based on previous detection of the ball in every single camera. The multi-camera tracking module 126 then builds a unique 3D ball location with multi-cam stereo images. A pose ball detection module 128 may detect the ball with a pose context model when ball is held by a player. When a ball is held by a player, it may be difficult to detect the ball directly. Usually the ball is held in a player's hand or cradled near the body. Thus, the player presents some special pose characteristics when holding the ball. The pose-ball context can be determined and used to find the ball in the context of the special pose. Additionally, a jersey number recognition module 130 may recognize the jersey number of each player. The jersey recognition module provides a unique player identify with team information during a game. Given the jersey number and team information, various information can be determined about the player, such as name, age, role, and game history, etc.

Through the use of images obtained from high resolution cameras, the immersive viewing modules 104 are able to immerse an end user in a three-dimensional recreation of a sporting event or game. In embodiments, an end user is able to view gameplay from any point within the field of play. The end user is also able to view a full 360° of the game at any point within the field of play. Thus, in embodiments an end user may experience gameplay from the perspective of any player. The game may be captured via a volumetric capture method. For example, game footage may be recorded using thirty-eight 5K ultra-high-definition cameras that capture height, width and depth of data to produce voxels (pixels with volume). Thus, a camera system according to the present techniques may include multiple super-high-resolution cameras to capture the entire playing field. After the game content is captured, a substantial amount of data is processed, and all viewpoints of a fully volumetric three-dimensional person or object are recreated. This information may be used to render a virtual environment in a multi-perspective three-dimensional format that enables users to experience a captured scene from any angle and perspective, and can provide a true six degrees of freedom.

For ease of description, the present techniques are described using an American football game as an example. In embodiments, the American football described herein may be as played by the National Football League (NFL). Generally, football describes a family of games where a ball is kicked at various times to ultimately score a goal. Football may include, for example, association football, gridiron football, rugby football. American football may be a variation of gridiron football. While American football is described, the present techniques may apply to any event with a plurality of states and stages. An end user can be immersed in the event at various states and stages according to the techniques described herein.

FIG. 2 is a block diagram illustrating a field of play 200. The field of play 200 may be an American football field. An American football field is rectangular in shape with a length of 120 yards and a width of 53⅓ yards. Lines 202 and 204 along the perimeter of the field of play 200 may be referred to as sidelines. Lines 206 and 208 along the perimeter of the field of play 200 may be referred to as end lines. The goal lines 210 and 212 are located 10 yards from the end lines 206 and 208, respectively, to create end zones 218A and 218B. The yard lines are marked every 5 yards from one goal line 210 to the other goal line 212. Hash marks 214 may be short parallel lines that occur in one-yard increments between each yard line. Goalposts 220A and 220B may be located at the center of each end line 206 and 208. Additionally, the field of play may be adorned with logos and other emblems 216 that represent the team that owns the field.

The field of play 200 includes end zones 218A and 218B at each end of the field of play. During play, a first team is designated as the offense, and a second team is designated as the defense. The ball used during play is an oval or prolate spheroid. Typically, the offense controls the ball, while the defense is without control of the ball. The offense attempts to advance the ball down the length of the rectangular field by running or passing the ball while the defense simultaneously attempts to prevent the offense from advancing the ball down the length of the field. The defense may also attempt to take control of the ball. If a defense takes the ball from the offense during a round of play, it may be referred to as an interception. An interception may be a game state according to the present techniques.

Generally, to begin a round of play opposing teams line up in a particular format, formation, or package. A round of play may be referred to as a down. During each down, the offense is given an opportunity to execute a play to advance down the field. To begin a play, the offense and defense line up along a line of scrimmage according to various schemes. For example, an offense will line up in a formation in an attempt to overcome the defense and advance the ball toward the goal line 210/212. If the offense can advance the ball past the goal line 210/212 and into the end zone 218A/218B, the offense will score a touchdown and is awarded points. The offense is also given a try to obtain points after the touchdown. In embodiments, a touchdown may be a game state.

The game may begin with a kickoff, where a kicking team kicks the ball to the receiving team. During the kickoff, the team who will be considered the offense after the kickoff is the receiving team, while the kicking team will typically be considered the defense. After the kickoff, the offense must advance the ball at least ten yards downfield in four downs, or otherwise the offense turns the football over to the defense. If the offense succeeds in advancing the ball ten yards or more, a new set of four downs is given to the offense to use in advancing the ball another ten yards. Each down may be considered a game state. Moreover, each quarter may be a game state. Generally, points are given to the team that advances the ball into the opposing team's end zone or kicks the ball through the goal posts of the opposing team. The team with the most points at the end of a game wins. There are also a number of special plays that may be executed during a down, including but not limited to, punts, field goals, and extra point attempts. These special plays may also be considered a state of the game.

An American football game is about four hours in duration, including all breaks where no gameplay occurs. In some cases, about half of the four hours includes active gameplay, while the other half is some sort of break. As used herein, a break may refer to team timeouts, official timeouts, commercial timeouts, injury timeouts, halftime, time during transition after a turnover, and the like. In embodiments, determining the game status enables the application of different modules to obtain more accurate player/ball location. During a break, some modules may be bypassed to save processing cost, time, and power. During the break, the game state is static and does not require any updates. In embodiments, the game status may be detected based on the ball and player position. In particular, player and ball detection algorithms may be implemented along with a finite state machine (FSM) status detection that is based on player/ball position and motion. Varying states of an American football game may be determined and a ball location algorithm applied based on the state. The present techniques also include a fusion method to obtain a final, highly accurate ball trajectory. In embodiments, a view from a virtual camera may be generated that follows the action in the field by following the ball or a specific player's moving trajectory in three-dimensional space.

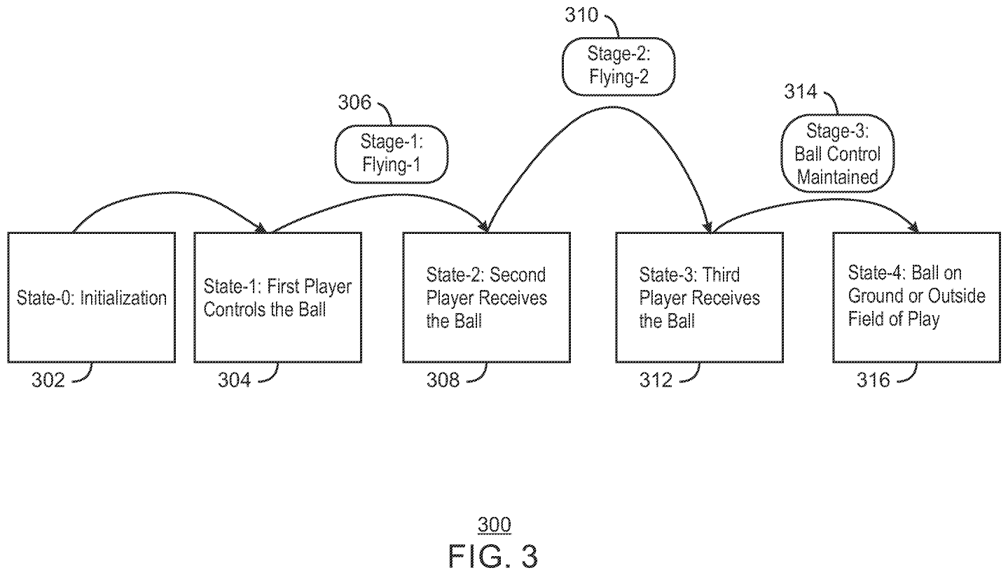

FIG. 3 is a block diagram illustrating the parsing of a round of play 300 into a plurality of states. Generally, a game begins at block 302 with a state-0. In state-0, a round of play or the entire game is initialized. For example, a kickoff occurs to initialize the beginning of an American football game. At block 304, game play begins as a first player obtains control of the ball and exchanges the ball with a second player. In the exchange between the first player in the second player, the ball may be placed by the first player directly into the hands of the second player. Alternatively, the first player may toss the ball several yards to the second player. Accordingly, at block 306 a stage-1 is illustrated. In the example of FIG. 3, the stage-1 is illustrated as a flying operation. However, the stage-1 may also be an exchange operation.

At block 308, a state-2 is described. During the state-2, the second player may receive the ball and make a decision regarding gameplay. In particular, the second player may decide to advance the ball down the field. Alternatively, the second player may hand the ball to a nearby third player so the nearby third player can advance the ball down the field. The second player may also pass the ball to a far-away third player that is several yards down the field in order to advance the ball down the field. At block 310, a stage-2 represents the movement of the ball from the second player to the third player.

At block 312, the third player receives the ball from the second player. Often, the third player will attempt to advance the ball even further downfield by holding the ball and running down the field. Accordingly, at block 314, a stage-3 occurs where the ball is held as it is advanced down the field by the third player. While not illustrated, the stages 306, 310, and 314 may be repeated numerous times to arrive at different game states according to the rules of play. For example, in American football, after the ball is obtained by the third player from the second player (where the second player is a quarterback and the first player is a center), the player may be prohibited from tossing the ball further downfield. However, the ball may be passed backwards in the field of play so that another player can attempt to advance the ball down the field by running. The round of play may end at block 316. At block 316, a state-4 is illustrated. In state-4, the current round of play in with the ball on the ground inside the field of play or the ball outside of the field of play.

In the example of FIG. 3, three stages of a game may be defined based on ball movement a first stage 306, in which the ball transitions from state-1 to state-2. A second stage 310 is illustrated where the ball transitions from state state-2 to state-3, and a third stage 314 is illustrated where the ball is controlled by a player. In some games, the ball may be controlled by a player who is able to direct the trajectory of the ball. In the example of American football, the ball may be controlled by a ball holding player (BHP) who advances the ball downfield. In another example, the ball may be controlled by a player who dribbles the ball using the hand, foot, or any combination thereof. Thus, the ball may be occluded by the controlling player's hands, feet, or body and not always visible.

In the stage-1 306 and stage-2 310, the ball is generally visible or partial occluded, and can be detected directly via object detection and tracking algorithm with dedicated effort. However, in stage-3 314, the ball is held by a player and may suffer from heavy occlusion and be invisible. As a result, the ball may not be directly detected when with a ball controlling player. If the position of the controlling player is known, then a rough position of the ball can be estimated. According to the present techniques, the game state may be determined through ball's motion and position. In embodiments, the game state may be based on ball detection and tracking in the full game, and the game state may be based on the tracking the ball controlling player stage-3. After obtaining two moving trajectories of the ball (first via ball detection and tracking and then via the ball controlling player), the trajectories are fused together to infer a final unique and smooth trajectory for ball tracking. While a game has been described generally, as a sequence of states and stages, each state and stage may be repeated according to the particular rules of game play. For some cases, a quarterback (QB) will attack directly to end zone instead of passing ball to another player especially near the end zone game. In these cases, there may be only stage-1 during the down.

The diagram of FIG. 3 is not intended to indicate that the example round of play 300 is to include all of the states and stages shown in FIG. 3. Rather, the example round of play 300 can be implemented using fewer or additional states and stages not illustrated in FIG. 3 (e.g., players, configurations, actions, termination of play, etc.).

Generally, a state of the game may refer to an event that occurs during gameplay. A stage may generally refer to an action that occurs during gameplay, where the action is defined by the movement or lack of movement of the ball or other object used during gameplay. The various stages of game play are often manually labeled with a game status by an operator inside stadium. However, manual labelling is not scalable due to many stadiums deployed, while also being inaccurate. Game status may also be determined via data from third party, for example, the text caption data. However, there is often a severe delay between the timestamp of the game and the timestamp of the caption data. Also, caption data is manually entered and labeled by a person. Traditionally, infer the motion status may be inferred from sensor data. However, sensors often need accurate calibration to ensure accurate tracking. There are often synchronization issues between the game and the sensors, and sensor can often be misaligned. Finally, broadcasting data can be used to determine game status, including video and audio, such as scene classification, whistle, or commentator's excited speech, etc. However, the broadcast data needs additional data resources and typically cannot be used in real-time productions. All of these solutions often introduce unnecessary delays. Moreover, to detect the ball, from the perspective of object detection, traditional solutions include general object detection and small size object detection. Due to poor quality of these optical approaches for ball tracking, RFID approaches may be used. However, these approaches do not result in an accurate and real-time three-dimensional location for the ball.

The present techniques use existing video data to detect game status to facilitate game analysis, which is light-weight and runs in real-time with low latency. The present techniques do not use third party data or additional sensors. In embodiments, if the ball is visible, a direct object detection algorithm is used. Otherwise, the ball-holding-player is found the ball position is inferred from the path of the ball holding player. The multiple trajectories may be combined via a fusion algorithm.

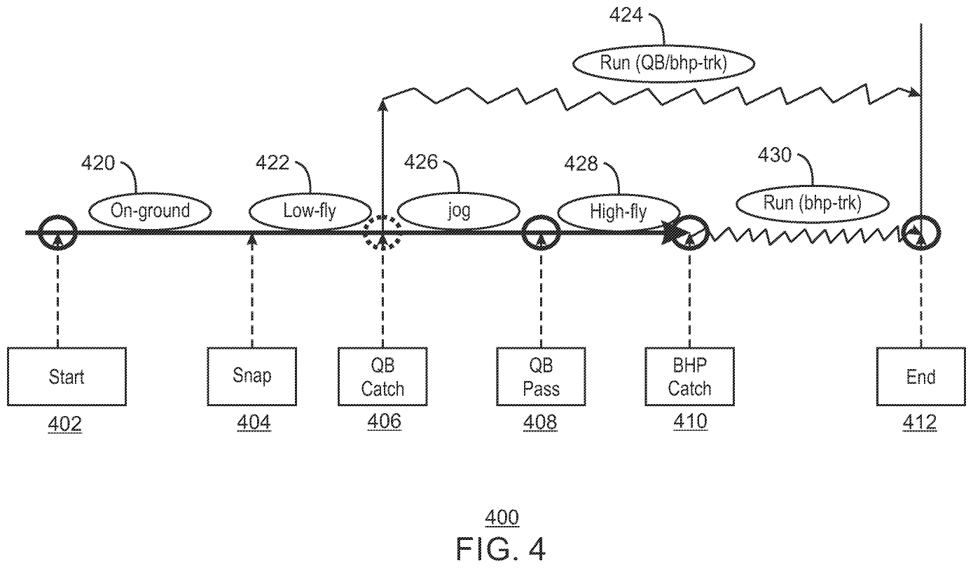

FIG. 4 is a block diagram illustrating a timeline 400 with states and stages of a down in an American football game. A down is an event in an American game during which an offense may execute a play. An offense is given a particular number of downs to advance the ball ten or more yards towards the end zone of the opponent. If an offense fails to advance the ball ten yards within the prescribed number of downs, the ball is turned over to the opponent. The ball may be turned over by punting the ball to their opponent, which causes the opponent to begin play further away from the desired end zone. Accordingly, a game may consist of several sets of downs.

Within a down, there may be various states at a number of points along the timeline 400. The timeline 400 includes state 402, state 404, state 406, state 408, state 410, and state 412. At state 402, game play begins. In the period of time that occurs between the state 402 and state 404, a stage 420 occurs. At stage 420, the ball may be placed on the ground. In American football, the ball may be placed on the ground by the center. At state 404, the players are static to initialize a play, which begins when the center snaps the ball. During a snap, the center hikes the ball to the quarterback. In the period of time that occurs between the state 404 and the state 406, a stage 422 occurs. At stage 422, the ball may be in a low fly state. A low fly state may be, for example, a short toss between two players that are relatively close. Based on the particular offensive scheme, the snap may be a handoff of the ball between the center's legs to the quarterback. In a shotgun formation, the quarterback may be positioned several yards behind the center. In such a formation, the ball is snapped several yards in a low fly stage to the quarterback.

At state 406, the quarterback receives the ball. Game progress may proceed along several paths based on decisions made by the quarterback. The quarterback may hand or toss the ball to a relatively close player. The quarterback may also keep the ball and run forward himself to advance the ball. Further, the quarterback may elect to pass the ball downfield to an eligible receiver. While particular options have been described for play in an American football game after the quarterback receives the snap, the present techniques are not limited to a particular game progress.

The options for the stages of the ball after the quarterback catches the snap at state 406 can be generally divided into two stages that cover various scenarios. At stage 424, the ball is in a running stage. Here, the ball remains with the quarterback or is pitched to an eligible player. Once the eligible player receives the ball, the eligible player may be referred to as a ball holding player. In this stage the player runs with the ball until game play is terminated for that down. Game play may be terminated for a down as described below. Note that the quarterback may keep the ball, begin running, and be designated as a ball holding player.

Alternatively, at stage 426 the quarterback may keep the ball without attempting to advance the ball down the field. In this scenario, the quarterback may be located within a pocket. The pocket is formed by members of the same team to form a protective area around the quarterback while the quarterback locates an eligible receiver downfield. Moving the pocket enables additional time for the quarterback to locate an eligible receiver, and also helps the quarterback to avoid being sacked. A sack refers to downing the quarterback by the defense during a down, such that game play terminates for that particular down. Thus, at stage 426, it may appear that the quarterback is slightly jogging in place. In some cases, this may be referred to as “dancing around the pocket.”

At state 408, the quarterback may pass the ball to an eligible downfield receiver. An American football, an eligible downfield receiver must be a particular number of yards beyond the line of scrimmage. At stage 428, the ball is in the air in a high fly position. At state 410, the ball is caught by an eligible receiver who is referred to as a ball holding player after the eligible receiver catches the ball. If the eligible receiver successfully catches the ball at state 410, the ball may enter stage 430. At stage 430, the ball holding player attempts to advance the ball downfield for additional yardage after the catch. Thus, at stage 430 the ball is in a running stage. In this stage, the ball holding player runs with the ball until game play is terminated for that down. In embodiments the ball holding player may create additional stages (not illustrated) by tossing the ball to other players in accordance with the rules of American football.

The play is over or dead when the ball holding player is declared down by an official, or the ball holding player leaves the field of play. The play may also be terminated when the ball holding player reaches the end zone of the opposing team. Reaching the end zone of the opposing team results in points being given. The end of the play is also the end of the down. The play may also end at any time during any stage if the player with possession of the ball is down, be it the center, the quarterback, or any other player. An incomplete pass may also cause the end of the down. An incomplete pass is a pass that goes out of bounds, or is dropped or otherwise not caught by a receiver.

The diagram of FIG. 4 is not intended to indicate that the example timeline 400 is to include all of the states and stages shown in FIG. 4. Rather, the example timeline 400 can be implemented using fewer or additional states and stages not illustrated in FIG. 4 (e.g., players, configurations, actions, termination of play, etc.).

The present techniques may use different algorithms to calculate the game status based on the ball position and player position. In different states, different algorithms may be used to maintain accuracy. For example, from the start of play until a catch by a ball holding player, a direct ball tracking algorithm works well as it is visible without much occlusion. However, when the ball is held by a player (QB or bhp), a direct ball tracking algorithm may not be as effective since the ball is partially or totally invisible. Thus, the player is tracked to infer the ball's position.

From the viewpoint of player tracking, during in-game (from start to end) the number of players is limited and the computation complexity is also limited. However, while in break there may be many un-controlled cases. For example, during a break there may be many people in the field of play that results in longer time to process and possible risk to real-time streaming process. Accordingly, the present techniques include a faster lightweight player detection module to find players in field quickly while with proper accuracy.

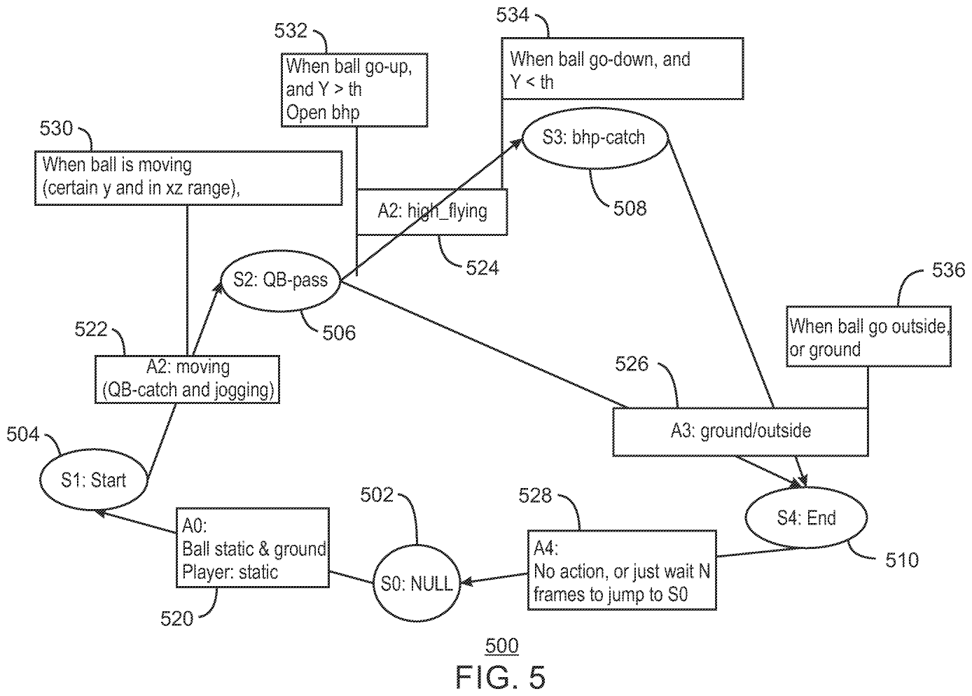

FIG. 5 is a game state transition graph 500. A Finite-State-Machine (FSM) may be used to detect game status as shown in FIG. 5. In the FSM, there are five actions, five states, and a number of transition conditions defined. An action is defined based on ball and player motion information. In the example of FIG. 5, a ball location algorithm and a faster lightweight player tracking algorithm are executed to find the ball and player position. The ball and player position may be used to detect game status. The action definition and also the action detection techniques are described below. The actions, stages, and states illustrated and described herein may be implemented via hardware, software, or any combination thereof. The finite state machine may take as input at least one of a ball position, ball trajectory, player position, player trajectory, or any combination thereof. The finite state machine outputs a state or stage of a game. The states include state 502, 504, 506, 508, and 510. The actions include action 520, action 522, action 524, action 526, an action 528. The transition conditions include condition 530, condition 532, condition 534, and condition 536.

At state 502, the state “S0: NULL” is an entrance empty state that represents the FSM starting. At action 520, the action “A0: ball is static and on-ground” occurs. Thus, at action 520, the ball and most players are almost static. Additionally, at action 520, the players stand in two parallel lines to begin a round of play. At state 504, the state is “S1: Start.” Thus, at state 504, normal play begins. At action 522, the action “A1: Moving” occurs. At the action 522, the ball is moving in low space, and low speed, as compared to high-space high-speed that may occur later during the play. At block 530, a transition condition is illustrated. The transition condition 530 is that the movement of the ball is a certain movement downfield above a threshold. In embodiments, the movement downfield may be along a Y-axis in the XZ plane. As used herein, a transition condition may refer to a change in ball movement or direction. The transition condition may also refer to ceasing movement of the ball. For example, after the ball is snapped to a quarterback the quarterback may then change the movement of the ball by initiating a pass downfield to a receiver or handing the ball to a running back. Thresholds may be applied to the movement or direction of the ball in order to create transition conditions.

At state 506, the state “S2: QB-pass” occurs. At state 506, the quarterback possesses the ball and will make a determination as to how the play will proceed. At block 532, a transition condition 532 occurs. At the transition condition 532, the ball is moving at a speed greater than a threshold th. When the ball is moving at a speed greater than the threshold th, the action 524 “A2: ball is high space flying” may occur. The action 524 represents a long-distance pass from the quarterback to a potential ball holding player. Alternatively, depending on the particular play executed, the transition condition 532 may be an exchange of the ball between the quarterback and a nearby player. In this scenario, the action 524 may be an “Exchange” or low flying pitch. At transition condition 534, the ball changes course from the state 524. In particular, the transition condition is a direction change of the ball, wherein the ball movement in the Y-axis is less than the threshold th. When the ball movement in the Y-axis is less than the threshold th, the state 508 occurs. Note that at state 506, if an action 526 occurs, a state 510 “S4: End” is entered. At state 510, the ball or the player in possession of the ball is downed. At state 510, the ball may also be beyond the field of play, and the round of play ends.

At state 508, a state “S3: BHP-catch” occurs. At state 508, the ball has transitioned from the quarterback to another player. The player that gains possession of the ball from the quarterback is known as a ball holding player (BHP). In embodiments, at state 506 (S2) and state 508 (S3), the ball may be flying high. During these states, based on the ball and the player's position, the ball holding player can be identified, and then the ball is tracked based on the identified ball holding player is tracked. At action 526, an action “A3: ball is court outside to inside, or on-ground” occurs. At action 526, the ball is grounded or outside the field of play. At action 526, typically the ball is held by players and cannot be directly located. However, the location of the ball can be determined based on the ball holding player's number and motion.

Note that the designation of a ball holding player that occurs at state 508 may track any player that gains control of the ball after the possession of the ball by the quarterback at state 506. For example, the state 508 may also occur when a player of the opposing team becomes a ball holding player. This may occur, for example, when the offense allows an interception or other turnover of the ball to the defense. Moreover, while the state 508 references a ball holding player “catch,” the ball holding player may gain possession of the ball in any number of ways. For example, the ball holding player may obtain the ball via a toss, pitch, or other short exchange between the quarterback and the player. The ball holding player may obtain the ball after a fumble or other loss of the ball by the quarterback. For example, a ball holding player on a same team as the quarterback may recover the football after a fumble or other loss of the ball by the quarterback. The ball holding player on the opposing team may also recover the football after a fumble or other loss of the ball by the quarterback.

While not illustrated by the finite state machine 500, if the number of players on the field of play is bigger than a threshold (say 50), and the motion is slow, that may be an end cue of the round of play. An action 528 “A4: others that does not belong to above 5 actions” may occur at the end of the round of play. Once an action 528 occurs, the finite state machine may enter state 502 after N number of frames have occurred after the action 528. In this manner, when game play transitions between rounds of play, the null state is entered after a pre-determined length of time.

In embodiments, the states of the finite state machine may be based on the rules of play for the game. For example, in American football particular players of the offense are identified as being the first player to possess the ball at the beginning of a down. After movement of the ball that indicates the beginning of game play, the next particular occurrence is restricted according to the rules of play. Accordingly, the states of the game may be as prescribed by the particular rules of play of American football. Moreover, the stages in which movement of the ball occurs may be limited according to ball movement rules as prescribed by the particular rules of play of American football.

Accordingly, the state machine may be modified by adding a state, removing a state, modifying a state, adding a stage that enables entry to a state, deleting a stage that enables entry to a state, adding an exit condition to a state, deleting an exit condition of a state, or any combinations thereof. Moreover, the finite state machine may be modified by adding one or more transition conditions, deleting one or more transition conditions, modifying an existing transition conditions, or any combination thereof. In this manner, the finite state machine may be configured according to states/stages of an American football game. Moreover, the finite state machine may be configured according to stages of an American football game according to rules promulgated by the NFL. The finite state machine may be configured to transition among the predefined states according to the tracking algorithm that yields ball position and the player position. A transition of the finite state machine into a state represents progression of game play.

The diagram of FIG. 5 is not intended to indicate that the example finite state machine 500 is to include all of the states and stages shown in FIG. 5. Rather, the example timeline 500 can be implemented using fewer or additional states and stages not illustrated in FIG. 5 (e.g., players, configurations, actions, termination of play, etc.).

As described above, the various states of a sporting event are dependent on a location of the game ball. In embodiments, the ball may be tracked according to an online ball moving trajectory fusion. In particular, the present techniques enable an optical solution to obtain an accurate ball trajectory. Most existing solutions use sensor/lidar/etc. device and need additional sync/alignment computing, with a low accuracy. Accordingly, the present techniques introduce different the various states of a game, and track the ball using multiple location algorithms as described above. An online fusion technique may be used to obtain an accurate ball trajectory. In embodiments, ball detection and tracking may be performed during the entire full game, and ball holding player ball tracking is executed whenever the ball suffers from partial occlusion.

The fusion technique described herein may be executed “online,” which means that the ball location fusion module may execute in real-time. Thus, the fusion module can process the input data immediately. In embodiments, a few frames may be buffered for processing by the fusion module. As a result, after the ball and ball holding player position is determined in the frame at index k, the fusion module processes the data and returns the output (fused trajectory) immediately. This is real time when compared to an “offline” mode, where a large buffer of frames is used which creates a long-term delay.

As generally described above, the present techniques may rely on 38 physical cameras with 5120×3072 resolution in stadium and conducts calibration before and during the game. A subset of cameras may be selected, such as eighteen cameras from among the thirty-eight cameras to cover the entire field of play and ensure that each pixel in the field of play is captured by at least three cameras for the purpose of ball location. The input of the present ball moving trajectory fusion is the real-time video stream from eighteen cameras (5120×3072) with 30 frames per second (fps), and output is the real-time 3D ball location (x, y, z in the world coordinates). The subset of cameras selected may be different in different scenarios. For example, depending on the structure surrounding the field of play, each location may be captured by at least three cameras using a smaller or larger subset of cameras. Overall, the selection of a subset of cameras for real-time three-dimensional ball location is a between accuracy and performance, where performance includes a speed of processing. Selecting all cameras enables an accurate ball location result. However, the use of all cameras results in more data processing, which ultimately uses more compute resources and the resulting speed with which is ball is rendered is slower. If a subset of cameras is used that enables adequate coverage of the entire field of play, the accuracy of the present techniques may be similar to the scenario when all cameras are used. However, fewer compute resources are used.

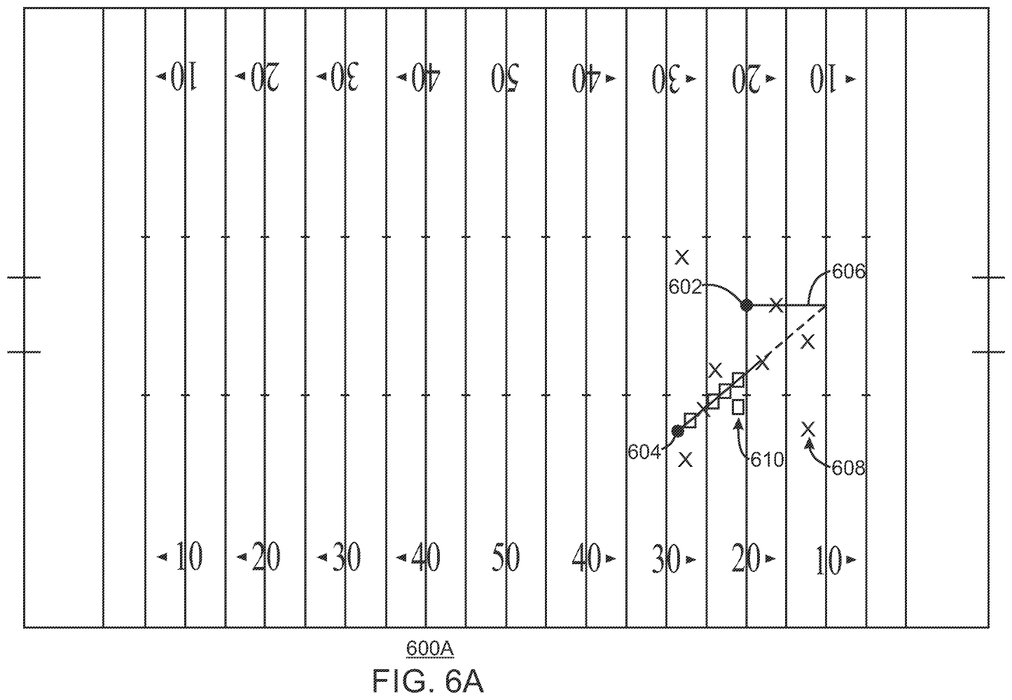

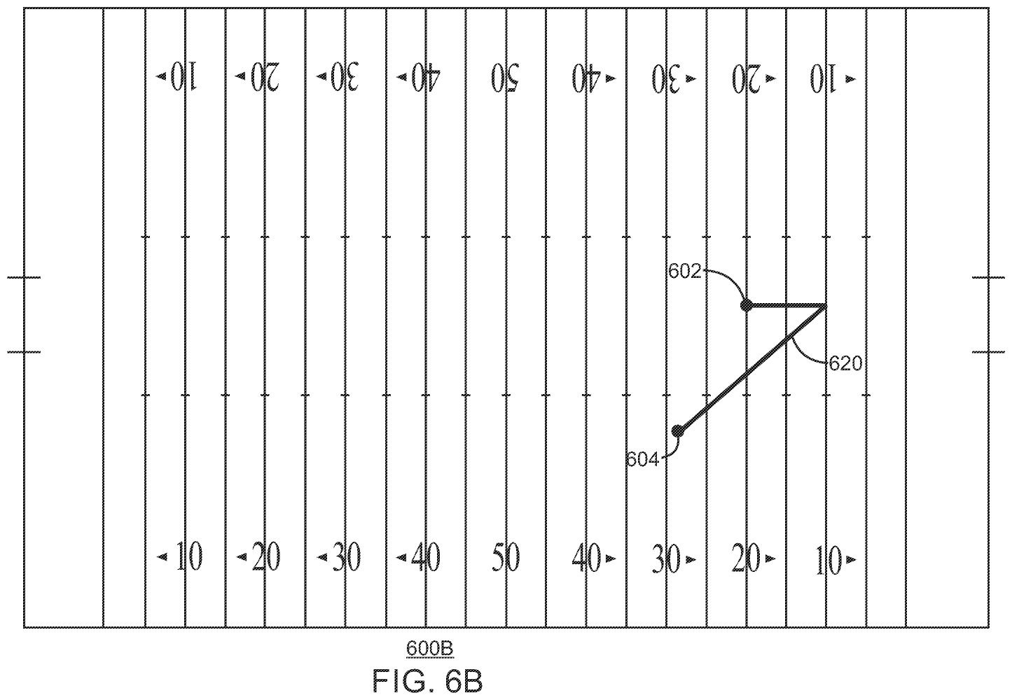

FIG. 6A is an illustration of multiple trajectories 600A. In particular, the trajectories 600A include the ball tracking trajectory and ball holding player tracking trajectory. In the example of FIG. 6A, a ball may begin at location 602 during a round of play and end at location 604 at the end of a round of play. The line 606 from location 602 to location 604 represents a ground truth trajectory of the ball during the round of play. In embodiments, the ball is visible and can be tracked using visible ball tracking as indicated by the plurality of X's 608. The plurality of X's 608 illustrates various locations of the ball as calculated via the visible ball tracking. A plurality of boxes 610 illustrate the location of the ball as estimated tracking of the ball holding player.

At the beginning of a game, the ball is visible and can be found according to a general ball detection algorithm. A first tracklet may be generated by the generally ball detection algorithm. A tracklet is a portion of a ball trajectory as generated according to any ball detection algorithm as described herein. In embodiments, a tracklet that occurs during a generally ball detection algorithm, where the ball is visible for a certain period of time, may be referred to as a major tracklet. Typically, the major tracklet occurs between This a stage “stage-1” and a “stage-2.” At stage “stage-3,” there may be both ball tracking and bhp tracking for the trajectory of the ball. However, tracking results at stage-3 are often inaccurate due to occlusion, gathering together of players, fast motion, and the like. At stage-3, usually one of the ball trajectories is accurate and near the ground truth trajectory. The trajectories include either the ball-raw (result from ball tracking) tracking or ball holding player tracking (ball position estimated from bhp tracking) as being stable. As illustrated, there are many isolated outlier points in each of the ball detection tracking and the ball holding player tracking (as illustrated, X's and squares) scattered in the field that are addressed during fusion. For ease of description, ball location according to both the direct ball tracking algorithm and the ball holding player tracking algorithm are illustrated in two dimensions in the XZ plane. However, the ball trajectory fusion according to the present techniques may occur in three dimensions, thereby incorporating height into the trajectory tracking.

In embodiments, a motion model may be built based on historical data. Usually, the ball motion is continuous and like a parabola. The ball motion may be estimated using a six state Kalman filter to estimate the motion. A state of the ball X may be defined as follows:

X=(x,y,z,Δx,Δy,Δz)

In this state of the ball, a position and velocity of the ball in three dimensions, along three axes X, Y, and Z, are considered. A linear motion model may be used to predict the position of the ball (and thus the state X of the ball) in the next frame as follows:

xₖ=AXₖ₋₁+wₖ₋₁

yₖ=Hxₖ+vₖ

In which,

$$A = [ \begin{matrix}1 , 0 , 0 , 1 , 0 , 0 \\ 0 , 1 , 0 , 0 , 1 , 0 \\ 0 , 0 , 1 , 0 , 0 , 1 \\ 0 , 0 , 0 , 1 , 0 , 0 \\ 0 , 0 , 0 , 1 , 0 , 0 \\ 0 , 0 , 0 , 0 , 0 , 1\end{matrix} ]$$

Where A is state transition matrix that transitions from time (k−1) to time k. For example, x_k=1*x_(k−1)+Δx, means the position of x at time k is position at time k−1 plus its speed (x as used in this example is different from the x in the above formulas. Additionally, H is a diagonal eye matrix with size 6×6, wₖ is a process noise variable, and vₖ is an observation noise variable. In particular, H is the observation model while maps the state space into the observed space.

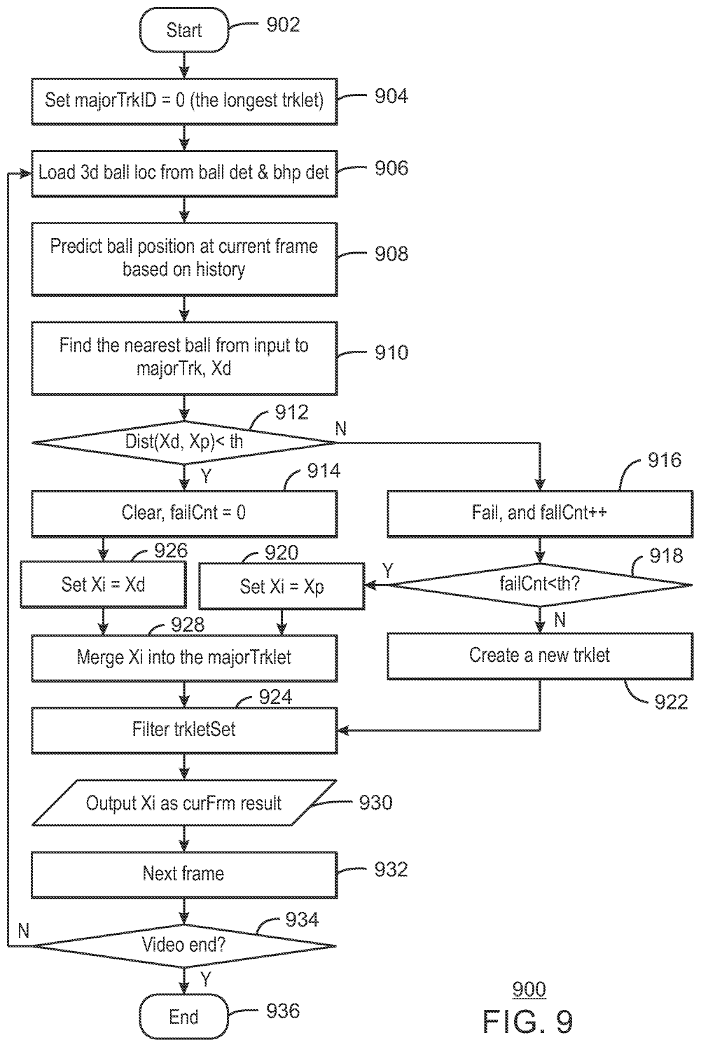

In embodiments, if the predicted ball location is near to the nearest detection instance, the detection result is merged into the major tracklet. Otherwise, the predicted result is used as the current ball location if the continuous failure number is less than certain frames. If the continuous failure count is greater than certain frames, a new tracklet is created. In embodiments, the continuous failure count may be any number of failures, such as five. These techniques are further described with regard to FIG. 9.

FIG. 6B is an illustration of a fused trajectory 620. The fused trajectory is a result of the combination of trajectories from ball tracking and bhp tracking as described with respect to FIG. 6B. The fused trajectory result 620 includes including ball tracking, bhp tracking, fused, and ground truth result using the same game data as FIG. 6A.

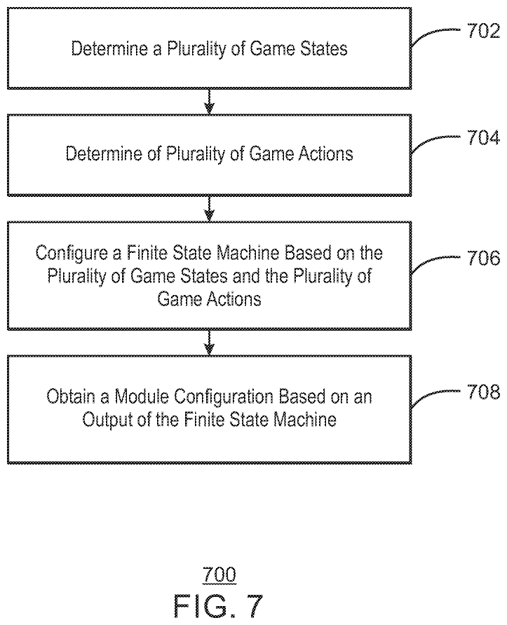

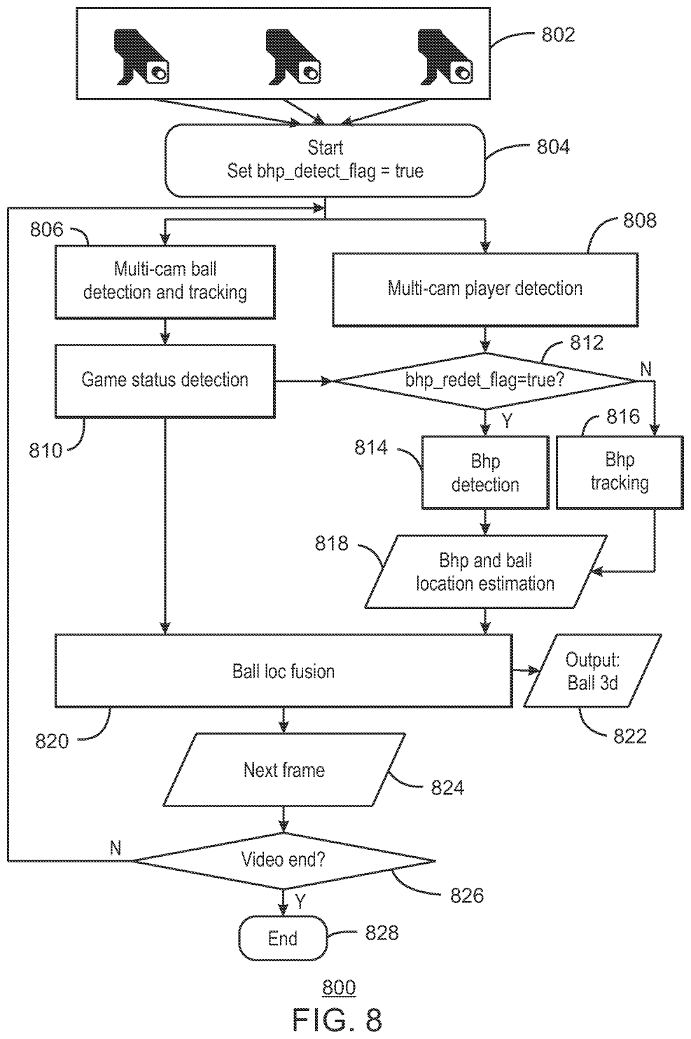

FIG. 7 is a process flow diagram of a method 700 for game status detection. At block 702, a plurality of game states is determined. At block 704, a plurality of game actions in determined. In embodiments, the game states and game actions may be derived from rules of play. The ball position may be determined as described below in FIGS. 8-12. At block 706, a finite state machine is configured to determine a state of a game based on the ball information and the player information. In response to the game status, various computing modules can be enabled or disabled to reduce power and computational complexity. At block 708, a configuration of modules may be determined based on the output of the finite state machine.

In embodiments, the ball and player position are obtained with ball and player detection and tracking algorithm in multiple-camera architecture. The ball and player's moving trajectory may be obtained and used to configure finite state machine to model the game pattern, and detect game status. Once the game status is obtained, computing modules may be enabled or disabled according to system configuration to save cost and power. Again, while American football is used as an example herein, the present techniques apply to other sports as well. These sports may include, for example, association football (soccer) and basketball.

Implementing an accurate and real-time low-latency game status detection as described herein enables complex ball tracking, such as the ball tracking that occurs during an American football game. In particular, the ball tracking as described herein enables the right algorithm in different stages of play. Furthermore, by identifying break time during which there are too many persons appearing on the playfield via game status detection, the present techniques can intelligently run player tracking algorithm during normal play and not during a break. This guarantees real-tracking while enabling a significant savings in compute resources. In embodiments, ball location algorithm as described herein can be used to create virtual camera streams, where the virtual camera can always follow the action in in a game via ball tracking.

FIG. 8 is an illustration of a process flow diagram of a multiple-camera ball location method 800. The method 800 includes a multiple-camera ball detection & tracking method 806, game status detection method 810, a multiple-camera player detection and tracking method 808, a ball holding player detection method 814, a ball holding player tracking method 816, a ball holding player and ball location estimation method 818, and ball location fusion method 820. The ball location fusion method is further described with respect to FIG. 9.

A plurality of images may be obtained from an array of cameras at block 802. At block 804, a ball location algorithm is initialized. In embodiments the initialization of the ball location algorithm sets a ball holding player detection flag equal to true. In embodiments, the ball holding player detection flag is used to determine if the ball is controlled by a player on the field. For example, at the beginning of an American football down, a player known as the center controls the ball on the ground as the quarterback audibles the play to be executed during the down.

At block 806, multiple camera ball detection and tracking is executed. Simultaneously, at block 808 multiple camera player detection is executed. Referring again to block 806, during multiple camera ball detection and tracking, a plurality of algorithms may be used to detect and track the ball as described above. In embodiments, at block 806 the ball may be detected with a multiple-camera solution. Once the ball is detected, it is tracked in a local range to accelerate the location procedure in each single camera. A three-dimensional ball location may be built in a multiple-camera framework since all cameras are well calibrated and are limited by an epipolar constraint. With the epipolar/multiple-camera constraint, false alarms may be removed, and the unique correct ball is found. The epipolar constraint enables a conversion between two dimensional and three-dimensional locations. Put another way, a 3D point in a world coordinate can project to different 2D cameras, and the projected position of the 3D object should meet some relation. For example, if the 3D object position is known along with the projection matrix of each camera, the objects 2D projected position can be determined. Further, if the camera parameters and 2D position in each camera are known, then the 3D position of the object may be determined. Additionally, as used herein a false alarm refers to a false detection in some cameras. In each single camera detection, there are correct detection and/or false detection. A false detection means the object detected is not a ball, but the detector has labeled it a ball. It is difficult to determine if the ball detection is false using a single camera. With the multiple-camera constraint, false balls are typically not detected in a single camera view. Accordingly, the false alarm detection can be eliminated or removed in single camera ball detection.

Referring again to block 806, the output of the multiple camera ball detection and tracking module is [frmNo, x, y, z], where “frmNo” is a timestamp that corresponds to a particular frame and “x, y, z” is the three-dimensional ball location in a world coordinate system. At block 806, when ball is flying in the air (as in stage-2), the ball detection accuracy is quite high. However, if the ball is held by player, the ball detection accuracy is at block 806 is lower. In examples, ball detection and tracking at block 806 may occur as described at block 110 of FIG. 1.

The ball location and player tracking determined at block 806 may be sent to a game status detection module at block 810. The game status detection module at block 810 may be the same as the game status detection module 112 of FIG. 1. With ball location from module-1 block 806, the game state can be determined, along with a moment of state switch. In stage-1 and stage-2, the output of direct ball detection is reliable at block 806. However, while in stage-3, the ball is blocked by player and cannot be detected due to non-visibility. Thus, to further refine the tracking of the ball, the game status detection may be used to determine a status of a ball holding player re-detection flag at block 812. The game status detection information from block 810 may also be sent a ball location fusion module at block 820.

At block 808, multiple camera player detection is executed. At block 808, all players in all cameras in the playfield are detected, and ID of the players may be associated across cameras and temporal. For a player, the position of the player may be determined via a bounding box in each camera. At block 812, it is determined if the ball holding player redetection flag is equal to true. If the ball holding player re-detection flag is equal to true, process flow continues to block 814 where the ball holding player is detected. If the ball holding player re-detection flag is not equal to true, process flow continues to block 816, where ball holding player tracking occurs. In this manner, the ball holding player re-detection flag indicates that a same ball holding player controls the ball. Accordingly, the same ball holding player is tracked at block 816. However, if the ball holding player re-detection flag is set to true, this indicates that control of the ball has shifted to another player. Accordingly, at block 814 the ball holding player is detected.

At block 814, ball holding player detection occurs. In the example of American football, when player tries to catch the ball, the pose of the player is different from other poses that occur during the game. The moment that the player receives the ball may be determined based on this pose. In this manner, the moment that one player receives the ball is identified, and player tracking is employed to infer the ball position. The ball holding player detection module 814, first each player's position is obtained, and a two-dimensional human pose is extracted and used to build a three-dimensional skeleton to determine if the player catches the ball (this player is the BHP target). In embodiments, a regression may be used to detect the ball holding player with highest confidence in a specific range around the ball.

At block 816, ball holding player tracking occurs. At block 816, single person tracking is executed to track the person's moving trajectory in each camera. The three-dimensional foot center is then built across all cameras. Once the three-dimensional position of the ball holding player's foot, the ball position is assumed to be at least higher that 0.5 meters based on the location of the ball holding player's foot. While this is a rough estimation, the accuracy is enough for camera engine purpose. The output of ball holding player tracking at block 816 is [frmNo, x, y, z] for each frame.

At block 818, the ball holding player position and tracking information as well as an estimation of the ball location is determined. The ball holding player position and tracking information and estimates of the ball location is transmitted to the ball location fusion module at block 820. Ball trajectory fusion may occur as described with respect to FIG. 9. The input to ball location fusion at block 820 is two ball moving trajectories from ball detection & tracking module 806 and bhp detection & tracking module 814/816, and the output is a ball position at current frame from a fused continuous trajectory at block 822. The detailed flowchart is shown in FIG. 9.

Thus, the ball location fusion module takes as input a game status, the ball holding player, and a ball location estimation, and outputs a trajectory of the ball. In embodiments, the trajectory is a three-dimensional trajectory of the ball throughout a field of play. At block 824, a next frame is obtained. At block 826, it is determined if the end of the video has been reached. If the end of the video has not been reached, process flow returns to block 804, where the ball holding player detection flag is set true. If the end of the video has been reached, then process flow continues to block 828 where the process ends.

This process flow diagram is not intended to indicate that the blocks of the example process 800 are to be executed in any particular order, or that all of the blocks are to be included in every case. Further, any number of additional blocks not shown may be included within the example process 800, depending on the details of the specific implementation.

FIG. 9 is a process flow diagram illustrating a method 900 for ball location fusion. In embodiments, the input to the method 904 ball location fusion is one or more ball moving trajectories obtained from a ball detection and tracking module and a ball holding player detection and tracking module. The output of the method or ball location fusion is a ball position at a current frame from a fused continuous trajectory. In embodiments, the output of the ball location fusion is a particular ball position for each frame, where in a ball position in a sequence of frames generates a used continuous trajectory.

At block 902, ball location fusion starts. At block 904, a major tracklet is identified. In embodiments, the major tracklet is a longest tracklet of a series of frames. At block 906, a three-dimensional ball location is obtained. In embodiments, the three-dimensional ball location may be obtained from a ball detection module and a ball holding player detection module. At block 908, a ball position within the current frame is predicted based on historical ball position data. At block 910 a nearest ball location from the input to the major track is identified. At block 912 the distance between the predicted and the nearest ball location from the input is determined. If the distance is less than a threshold, process flow continues to block 914. If the distance is greater than a threshold, process flow continues to block 916. In this manner, if a ball location obtained from the input of the two trajectories is far enough from a predicted location, then tracking and the ball may be obscured or somehow not visible. At block 916, a trajectory failure is determined and a failed count is incremented. At block 918 it is determined if the failed count is less than a second threshold. If the failed count is less than a second threshold, process flow continues to block 920. At block 920 an intermediate ball location is set equal to the predicted ball location. In this manner, a random outlier data point does not cause the creation of a new tracklet. Instead, the tracklet continues with the predicted location. However, if the failed count is not less than a second threshold process flow continues to block 922. In this scenario, the number of failed data points is greater than the second threshold which indicates a series of ball locations from the predicted. Accordingly, at block 922 a new tracklet is created, and process flow continues to block 924.

If at block 912, the distance between a nearest ball location from the input and the predicted ball location is less than the first threshold, process flow continues to block 914. At block 914 the failed count is cleared and set to zero. At block 926, the intermediate ball location is set equal to the nearest ball location from the two input trajectories. In this manner, a closest ball location from the two trajectories is used to represent the location of the ball in the frame. At block 928, the intermediate ball location is merged into the major tracklet.

At block 924, the tracklet set is filtered. As used herein, a tracklet refers to a short trajectory. If a tracklet is too short and cannot be merged into a long trajectory, it may be considered a false trajectory and is removed or filtered out of the set of tracklets. At block 930, the intermediate ball location is output as the resulting ball location for the current frame. At block 930 to the next frame is obtained. At block 934, is determined if the end of the video is reached. If the end of the video has not been reached, process flow returns to block 906. If the end of the video has been reached, process flow continues to block 936. At block 936 the ball location fusion method ends. Trajectory fusion as described herein enables an increase in trajectory accuracy when compared to direct ball tracking and inferred ball holding player tracking.

This process flow diagram is not intended to indicate that the blocks of the example process 900 are to be executed in any particular order, or that all of the blocks are to be included in every case. Further, any number of additional blocks not shown may be included within the example process 900, depending on the details of the specific implementation.

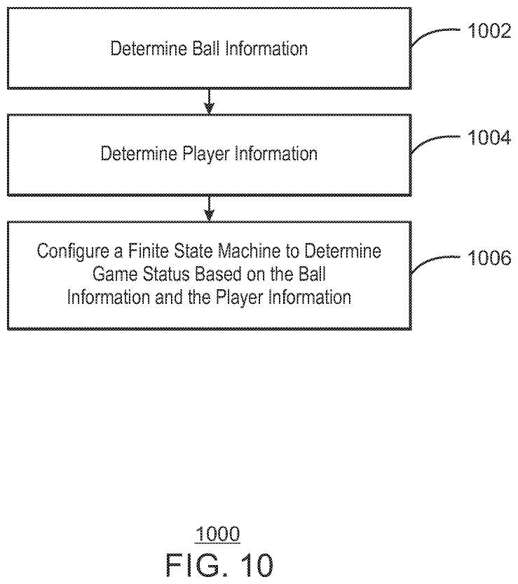

FIG. 10 is a process flow diagram of a method 1000 for game status detection with ball location fusion. At block 1002, ball information of a frame is determined. In embodiments, a tracking algorithm to obtain a ball position in a multiple-camera architecture is executed. The ball position may be determined as described below in FIGS. 9 and 10. At block 1004, a player information is determined. In embodiments, the player information can be determined via a lightweight tracking algorithm. At block 1006, a finite state machine is configured to determine a state of a game based on the ball information and the player information. In response to the game status, various computing modules can be enabled or disabled to reduce power and computational complexity.

This process flow diagram is not intended to indicate that the blocks of the example process 1000 are to be executed in any particular order, or that all of the blocks are to be included in every case. Further, any number of additional blocks not shown may be included within the example process 1000, depending on the details of the specific implementation.

As described herein, the present techniques enable an effective trajectory fusion method to combine two input trajectories. An American football game state parsing algorithm as described herein invokes a correct ball tracking algorithm and fuses the results of all algorithms to output ball location. During fusion, an efficient and high accurate ball detection method is executed to detect the ball in the air. The entire game is parsed into several logical stages based on ball detection result. The parsing of the game enables the development proper algorithms to locate the ball for each stage.

A mechanism according to the present techniques may be used to generate a tracklet by merging new data. The generation of the final tracklet does not result in a delay to obtain a smooth result. A motion model may be built to predict the ball location at the next frame to meet a low latency requirement to enable an immersive viewing experience for an end user. With ball detection, ball holding player tracking and trajectory fusion method, the present techniques can find the ball location all through the game regardless of the ball is visible or invisible. A ball may be invisible when it is occluded or otherwise partially viewable, such as when it is held by a player.

As described herein, the ball is the focus of a game, and many events/behaviors/strategies are based on ball position. Obviously, ball location is a fundamental and critical IP in sports analytic system. Ball detection according to the present techniques enables the development of freeze moments in highlight detection, real-time path control, high-quality three-dimensional ball rendering, game tactics and performance statistics, and the like.

Compared to existing methods, the present techniques do not rely on expensive optical capture camera system, or additional sensors. The present techniques can locate the small fast game focus with very high accuracy and performance in a whole game. In particular, the present techniques use a multiple-camera optical system to locate a ball during an American football game with high and robust accuracy. Most existing solutions use sensor/lidar/etc. with additional device and sync/alignment effort, and the accuracy is not very high.

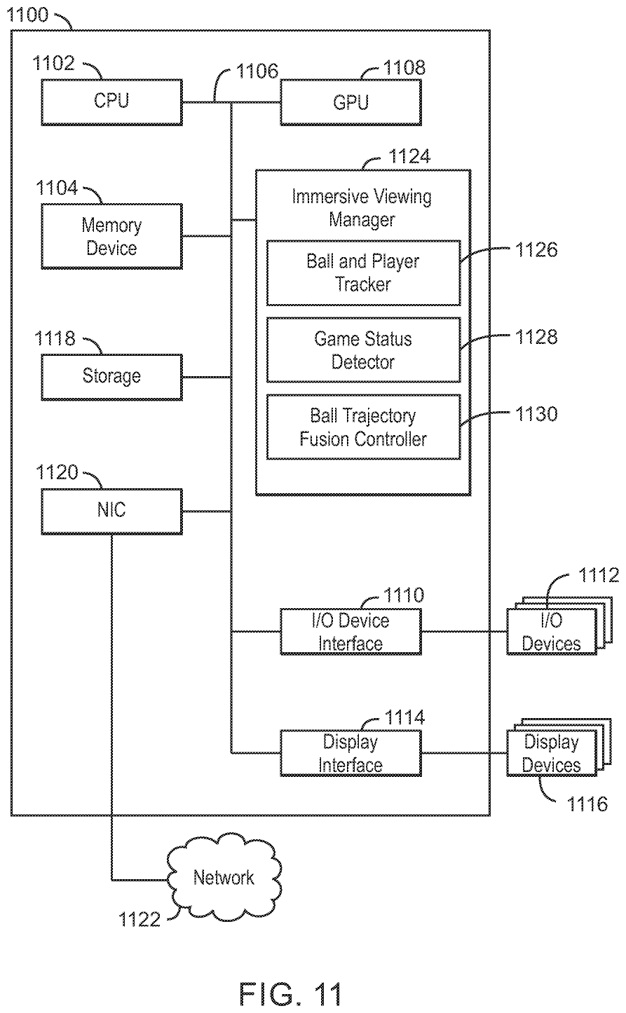

Referring now to FIG. 11, a block diagram is shown illustrating game status detection and trajectory fusions. The computing device 1100 may be, for example, a laptop computer, desktop computer, tablet computer, mobile device, or wearable device, among others. In some examples, the computing device 1100 may be a smart camera or a digital security surveillance camera. The computing device 1100 may include a central processing unit (CPU) 1102 that is configured to execute stored instructions, as well as a memory device 1104 that stores instructions that are executable by the CPU 1102. The CPU 1102 may be coupled to the memory device 1104 by a bus 1106. Additionally, the CPU 1102 can be a single core processor, a multi-core processor, a computing cluster, or any number of other configurations. Furthermore, the computing device 1100 may include more than one CPU 1102. In some examples, the CPU 1102 may be a system-on-chip (SoC) with a multi-core processor architecture. In some examples, the CPU 1102 can be a specialized digital signal processor (DSP) used for image processing. The memory device 1104 can include random access memory (RAM), read only memory (ROM), flash memory, or any other suitable memory systems. For example, the memory device 1104 may include dynamic random-access memory (DRAM).

The computing device 1100 may also include a graphics processing unit (GPU) 1108. As shown, the CPU 1102 may be coupled through the bus 1106 to the GPU 1108. The GPU 1108 may be configured to perform any number of graphics operations within the computing device 1100. For example, the GPU 1108 may be configured to render or manipulate graphics images, graphics frames, videos, or the like, to be displayed to a viewer of the computing device 1100.

The CPU 1102 may also be connected through the bus 1106 to an input/output (I/O) device interface 1110 configured to connect the computing device 1100 to one or more I/O devices 1112. The I/O devices 1112 may include, for example, a keyboard and a pointing device, wherein the pointing device may include a touchpad or a touchscreen, among others. The I/O devices 1112 may be built-in components of the computing device 1100, or may be devices that are externally connected to the computing device 1100. In some examples, the memory 1104 may be communicatively coupled to I/O devices 1112 through direct memory access (DMA).

The CPU 1102 may also be linked through the bus 1106 to a display interface 1114 configured to connect the computing device 1100 to a display device 1116. The display devices 1116 may include a display screen that is a built-in component of the computing device 1100. The display devices 1116 may also include a computer monitor, television, or projector, among others, that is internal to or externally connected to the computing device 1100. The display device 1116 may also include a head mounted display.

The computing device 1100 also includes a storage device 1118. The storage device 1118 is a physical memory such as a hard drive, an optical drive, a thumbdrive, an array of drives, a solid-state drive, or any combinations thereof. The storage device 1118 may also include remote storage drives.

The computing device 1100 may also include a network interface controller (NIC) 1120. The NIC 1120 may be configured to connect the computing device 1100 through the bus 1106 to a network 1122. The network 1122 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 1100 further includes an immersive viewing manager 1124. The immersive viewing manager 1124 may be configured to enable a 360° view of a sporting event from any angle. In particular images captured by a plurality of cameras may be processed such that an end user can virtually experience any location within the field of play. In particular, the end user may establish a viewpoint in the game, regardless of particular camera locations used to capture images of the sporting event. The immersive viewing manager 1124 includes a ball and player tracker 1126. The ball and player tracker 1126 may be similar to the ball and player tracking module 110 of FIG. 1 and/or the ball detection and tracking 806 of FIG. 8. The immersive viewing manager also includes a game status detector 1128. The game status detector 1128 may be similar to the game status detection module 112 of FIG. 1 and/or the game status detection module 810 of FIG. 8. Finally, the immersive viewing manager also includes a ball trajectory fusion controller 1130. The ball trajectory fusion controller 1130 may enable ball location fusion as described at block 820 of FIG. 8 or the method 900 of FIG. 9.

The block diagram of FIG. 11 is not intended to indicate that the computing device 1100 is to include all of the components shown in FIG. 11. Rather, the computing device 1100 can include fewer or additional components not illustrated in FIG. 11, such as additional buffers, additional processors, and the like. The computing device 1100 may include any number of additional components not shown in FIG. 11, depending on the details of the specific implementation. Furthermore, any of the functionalities of the immersive viewing manager 1124, the ball and player tracker 1126, the game status detector 1128, or the ball trajectory fusion controller 1130, may be partially, or entirely, implemented in hardware and/or in the processor 1102. For example, the functionality may be implemented with an application specific integrated circuit, in logic implemented in the processor 1102, or in any other device. For example, the functionality of the immersive viewing manager 1124 may be implemented with an application specific integrated circuit, in logic implemented in a processor, in logic implemented in a specialized graphics processing unit such as the GPU 1108, or in any other device.

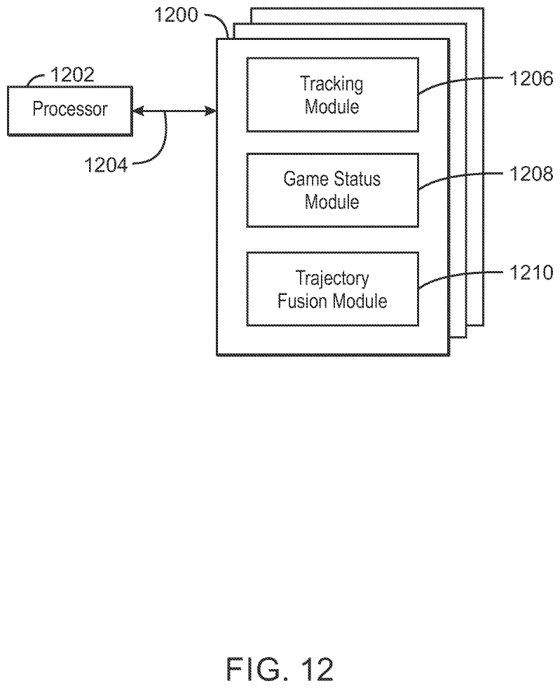

FIG. 12 is a block diagram showing computer readable media 1200 that store code for game status detection and trajectory fusion. The computer readable media 1200 may be accessed by a processor 1202 over a computer bus 1204. Furthermore, the computer readable medium 1200 may include code configured to direct the processor 1202 to perform the methods described herein. In some embodiments, the computer readable media 1200 may be non-transitory computer readable media. In some examples, the computer readable media 1200 may be storage media.

The various software components discussed herein may be stored on one or more computer readable media 1200, as indicated in FIG. 12. For example, a tracking module 1206 may be configured to track a ball and player. A game status module 1208 can be configured to determine a game status. A trajectory fusion module 1210 may be configured to fuse two trajectories of a ball during play. In embodiments, the tracking may be iterated during game play until the end of game play is reached.

The block diagram of FIG. 12 is not intended to indicate that the computer readable media 1200 is to include all of the components shown in FIG. 12. Further, the computer readable media 1200 may include any number of additional components not shown in FIG. 12, depending on the details of the specific implementation.

### Examples

Example 1 is a system for game status detection. The system includes a tracker to obtain a ball position and a player position based on images from a plurality of cameras; a fusion controller to combine multiple trajectories that are detected via the ball position to obtain a fused trajectory; and a finite state machine configured to model a game pattern, wherein a game status is determined via the ball position, the player position and the fused trajectory as input to the finite state machine, the finite state machine comprising: a plurality of states, wherein each state of the plurality of states is an occurrence during the game; and a plurality of stages, wherein each stage corresponds to an action that that takes place from a first state to a second state.

Example 2 includes the system of example 1, including or excluding optional features. In this example, at least one module is disabled based on a state of the game as determined by the finite state machine.

Example 3 includes the system of any one of examples 1 to 2, including or excluding optional features. In this example, the system includes a plurality of transition conditions, wherein the transition condition indicates the end of at least one stage of the plurality of stages.

Example 4 includes the system of any one of examples 1 to 3, including or excluding optional features. In this example, the tracker obtains the ball position via direct ball detection during the entirety of the game, and the tracker obtains the ball position via ball holding player tracking with a ball holding player is in possession of the ball.

Example 5 includes the system of any one of examples 1 to 4, including or excluding optional features. In this example, the fusion controller is to combine the multiple trajectories based on a comparison with a predicted ball trajectory.

Example 6 includes the system of any one of examples 1 to 5, including or excluding optional features. In this example, the type of tracking used to obtain the ball position is based on a state of the finite state machine.

Example 7 includes the system of any one of examples 1 to 6, including or excluding optional features. In this example, in response to accurate ball detection via an optical solution, the tracker is to track the ball based on a detected location of the ball.

Example 8 includes the system of any one of examples 1 to 7, including or excluding optional features. In this example, in response to partial or total occlusion of the ball during ball detection, the tracker is to track the ball based on an inferred position of the ball as possessed by a ball holding player.

Example 9 includes the system of any one of examples 1 to 8, including or excluding optional features. In this example, the player position is determined based on a bounding box applied to the player in each camera view.

Example 10 includes the system of any one of examples 1 to 9, including or excluding optional features. In this example, the plurality of states is based on rules of play of the game.

Example 11 is a method for game status detection. The method includes obtaining a ball position and a player position based on images from a plurality of cameras; combining multiple trajectories that are detected via the ball position to obtain a fused trajectory; and modeling a game pattern, wherein a game status is determined via the ball position, the player position and the fused trajectory as input to a finite state machine, the finite state machine comprising: a plurality of states, wherein each state of the plurality of states is an occurrence during the game; and a plurality of stages, wherein each stage corresponds to an action that that takes place from a first state to a second state.

Example 12 includes the method of example 11, including or excluding optional features. In this example, at least one module is disabled based on a state of the game as determined by the finite state machine.

Example 13 includes the method of any one of examples 11 to 12, including or excluding optional features. In this example, the method includes a plurality of transition conditions, wherein the transition condition indicates the end of at least one stage of the plurality of stages.

Example 14 includes the method of any one of examples 11 to 13, including or excluding optional features. In this example, the tracker obtains the ball position via direct ball detection during the entirety of the game, and the tracker obtains the ball position via ball holding player tracking with a ball holding player is in possession of the ball.

Example 15 includes the method of any one of examples 11 to 14, including or excluding optional features. In this example, the fusion controller is to combine the multiple trajectories based on a comparison with a predicted ball trajectory.

Example 16 includes the method of any one of examples 11 to 15, including or excluding optional features. In this example, the type of tracking used to obtain the ball position is based on a state of the finite state machine.

Example 17 includes the method of any one of examples 11 to 16, including or excluding optional features. In this example, in response to accurate ball detection via an optical solution, the tracker is to track the ball based on a detected location of the ball.

Example 18 includes the method of any one of examples 11 to 17, including or excluding optional features. In this example, in response to partial or total occlusion of the ball during ball detection, the tracker is to track the ball based on an inferred position of the ball as possessed by a ball holding player.

Example 19 includes the method of any one of examples 11 to 18, including or excluding optional features. In this example, the player position is determined based on a bounding box applied to the player in each camera view.

Example 20 includes the method of any one of examples 11 to 19, including or excluding optional features. In this example, the plurality of states is based on rules of play of the game.

Example 21 is at least one non-transitory computer-readable medium. The computer-readable medium includes instructions that direct the processor to obtain a ball position and a player position based on images from a plurality of cameras; combine multiple trajectories that are detected via the ball position to obtain a fused trajectory; and model a game pattern, wherein a game status is determined via the ball position, the player position and the fused trajectory as input to a finite state machine, the finite state machine comprising: a plurality of states, wherein each state of the plurality of states is an occurrence during the game; and a plurality of stages, wherein each stage corresponds to an action that that takes place from a first state to a second state.

Example 22 includes the computer-readable medium of example 21, including or excluding optional features. In this example, at least one module is disabled based on a state of the game as determined by the finite state machine.

Example 23 includes the computer-readable medium of any one of examples 21 to 22, including or excluding optional features. In this example, the computer-readable medium includes a plurality of transition conditions, wherein the transition condition indicates the end of at least one stage of the plurality of stages.

Example 24 includes the computer-readable medium of any one of examples 21 to 23, including or excluding optional features. In this example, the tracker obtains the ball position via direct ball detection during the entirety of the game, and the tracker obtains the ball position via ball holding player tracking with a ball holding player is in possession of the ball.

Example 25 includes the computer-readable medium of any one of examples 21 to 24, including or excluding optional features. In this example, the fusion controller is to combine the multiple trajectories based on a comparison with a predicted ball trajectory.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. A system for game status detection, the system comprising:
a tracker to obtain a ball position and a player position based on images from a plurality of cameras;
a fusion controller to combine multiple trajectories that are detected via the ball position to obtain a fused trajectory; and
a finite state machine configured to model a game pattern, wherein a game status is determined via the ball position, the player position and the fused trajectory as input to the finite state machine, the finite state machine comprising including:
a plurality of states, wherein each state of the plurality of states is an occurrence during the game; and
a plurality of stages, wherein each stage corresponds to an action that that takes place from a first state to a second state.

2. The system of claim 1, wherein at least one module is disabled based on a state of the game as determined by the finite state machine.

3. The system of claim 1, wherein the finite state machine further includes a plurality of transition conditions, wherein at least one of the transition condition indicates the end of at least one stage of the plurality of stages.

4. The system of claim 1, wherein the tracker is to obtain the ball position via direct ball detection during the entirety of the game, and ball holding player tracking with a ball holding player is in possession of the ball.

5. The system of claim 1, wherein the fusion controller is to combine the multiple trajectories based on a comparison with a predicted ball trajectory.

6. The system of claim 1, wherein the type of tracking used by the tracker to obtain the ball position is based on a state of the finite state machine.

7. The system of claim 1, wherein, in response to accurate ball detection via an optical solution, the tracker is to track the ball based on a detected location of the ball.

8. The system of claim 1, wherein, in response to partial or total occlusion of the ball during ball detection, the tracker is to track the ball based on an inferred position of the ball as possessed by a ball holding player.

9. The system of claim 1, wherein the tracker is to obtain the player position based on a bounding box applied to the player in each camera view.

10. The system of claim 1, wherein the plurality of states is based on rules of play of the game.

11. A method for game status detection, comprising:
obtaining a ball position and a player position based on images from a plurality of cameras;
combining multiple trajectories that are detected via the ball position to obtain a fused trajectory; and
modeling a game pattern, wherein a game status is determined via the ball position, the player position and the fused trajectory as input to a finite state machine, the finite state machine including:
a plurality of states, wherein each state of the plurality of states is an occurrence during the game; and
a plurality of stages, wherein each stage corresponds to an action that that takes place from a first state to a second state.

12. The method of claim 11, further including disabling at least one module is disabled based on a state of the game as determined by the finite state machine.

13. The method of claim 11, wherein the modelling the game pattern is based on a plurality of transition conditions of the finite state machine, wherein at least one of the transition conditions indicates the end of at least one stage of the plurality of stages.

14. The method of claim 11, wherein the the ball position is obtained via direct ball detection during the entirety of the game, and ball holding player tracking with a ball holding player is in possession of the ball.

15. The method of claim 11, further including combining the multiple trajectories based on a comparison with a predicted ball trajectory.

16. The method of claim 11, wherein the type of tracking used to obtain the ball position is based on a state of the finite state machine.

17. The method of claim 11, further including, in response to accurate ball detection via an optical solution, tracking the ball based on a detected location of the ball.

18. The method of claim 11, further including, in response to partial or total occlusion of the ball during ball detection, tracking the ball based on an inferred position of the ball as possessed by a ball holding player.

19. The method of claim 11, wherein the player position is obtained based on a bounding box applied to the player in each camera view.

20. The method of claim 11, wherein the plurality of states is based on rules of play of the game.

21. At least one non-transitory computer-readable medium, comprising instructions, which when executed, cause a processor to:
obtain a ball position and a player position based on images from a plurality of cameras;
combine multiple trajectories that are detected via the ball position to obtain a fused trajectory; and
model a game pattern, wherein a game status is determined via the ball position, the player position and the fused trajectory as input to a finite state machine, the finite state machine including:
a plurality of states, wherein each state of the plurality of states is an occurrence during the game; and
a plurality of stages, wherein each stage corresponds to an action that that takes place from a first state to a second state.

22. The computer-readable medium of claim 21, wherein the instructions cause the processor to disable at least one module based on a state of the game as determined by the finite state machine.

23. The computer-readable medium of claim 21, wherein the modeling the game pattern is based on a plurality of transition conditions of the finite state machine, wherein the transition condition indicates the end of at least one stage of the plurality of stages.

24. The computer-readable medium of claim 21, wherein the ball position is obtained via direct ball detection during the entirety of the game, and ball holding player tracking with a ball holding player is in possession of the ball.

25. The computer-readable medium of claim 21, wherein the instructions cause the processor to combine the multiple trajectories based on a comparison with a predicted ball trajectory.
